(19) United States
(12) Patent Application Publication
(10) Pub. No.: US 2023/0040462 A1
(43) Pub. Date: Feb. 9, 2023

(54) OPERATIONAL SYSTEM, OPERATIONAL METHOD, AND STORAGE MEDIUM

(71) Applicant: TOYOTA JIDOSHA KABUSHIKI KAISHA, Aichi-ken (JP)

(72) Inventor: Isao SATO, Nagoya-shi (JP)

(21) Appl. No.: 17/858,995

(22) Filed: Jul. 7, 2022

(30) Foreign Application Priority Data
Jul. 28, 2021 (JP) 2021-123168

(51) Int. Cl. G01C 21/34; G06Q 10/02

(52) U.S. Cl. CPC G01C 21/3476; G06Q 10/02; H01M 2250/20; B60L 50/70

(57) ABSTRACT

An operational system of the present disclosure is an operational system for a plurality of fuel cell electric vehicles. The operational system is equipped with a decision unit that decides a single operational route based on supply amounts of hydrogen available from a plurality of hydrogen stations respectively, from among a plurality of candidates of an operational route of each of the fuel cell electric vehicles, and a scheduling unit that schedules the filling of each of the fuel cell electric vehicles with hydrogen at the hydrogen station or hydrogen stations included on the decided operational route. The decision unit decides the new operational route based on post-change available supply amounts of hydrogen in the case where the supply amounts of hydrogen available from the respective hydrogen stations change when each of the fuel cell electric vehicles runs on the decided operational route.

### CROSS-REFERENCE TO RELATED APPLICATION

This application claims priority to Japanese Patent Application No. 2021-123168 filed on Jul. 28, 2021, incorporated herein by reference in its entirety.

### BACKGROUND

### 1. Technical Field

The present disclosure relates to an operational system, an operational method, and a storage medium, and more particularly, to an art of managing the operation of a fuel cell electric vehicle.

### 2. Description of Related Art

An operational system for a fuel cell electric vehicle is proposed. Japanese Unexamined Patent Application Publication No. 2016-183768 (JP 2016-183768 A) discloses an art of creating a reservation table of the filling of the fuel cell electric vehicle with hydrogen at a hydrogen station based on reservation information from a user, and securing required hydrogen by the previous day based on the reservation table.

### SUMMARY

According to the art described in JP 2016-183768 A, the user fills the fuel cell electric vehicle with hydrogen at a hydrogen station decided in advance. Accordingly, in the case where there is a plurality of hydrogen stations around an operational route, the status of utilization of each of the hydrogen stations cannot be taken into account, so it may take a long time to fill the fuel cell electric vehicle with hydrogen. Besides, in the case where the operational system includes a plurality of commercial vehicles, it is preferable to equalize the loads applied to the respective hydrogen stations with one another. This is because the commercial vehicles are filled with a large amount of hydrogen and hence require a long filling time.

The present disclosure has been made to solve this problem. It is an object of the present disclosure to provide an operational system, an operational method, and a storage medium that can reduce the time for filling each of fuel cell electric vehicles with hydrogen in consideration of the status of utilization of each of a plurality of hydrogen stations.

An operational system in the present disclosure is an operational system for a plurality of fuel cell electric vehicles. The operational system is equipped with a decision unit that decides a single operational route based on supply amounts of hydrogen available from a plurality of hydrogen stations respectively, from among a plurality of candidates of an operational route of each of the fuel cell electric vehicles, and a scheduling unit that schedules the filling of each of the fuel cell electric vehicles with hydrogen at the hydrogen station or hydrogen stations included on the decided operational route. The decision unit decides the new operational route based on post-change available supply amounts of hydrogen in the case where the supply amounts of hydrogen available from the respective hydrogen stations change when each of the fuel cell electric vehicles runs on the decided operational route.

An operational method in the present disclosure is an operational method for a plurality of fuel cell electric vehicles. The operational method includes a decision step of deciding a single operational route based on supply amounts of hydrogen available from a plurality of hydrogen stations respectively, from among a plurality of candidates of an operational route of each of the fuel cell electric vehicles, and a scheduling step of scheduling the filling of each of the fuel cell electric vehicles with hydrogen at the hydrogen station or hydrogen stations included on the decided operational route. In the decision step, the new operational route based on post-change available supply amounts of hydrogen is decided in the case where the supply amounts of hydrogen available from the respective hydrogen stations change when each of the fuel cell electric vehicles runs on the decided operational route.

A storage medium in the present disclosure stores an operational program that causes a computer to carry out an operational method for a plurality of fuel cell electric vehicles. The operational method includes a decision step of deciding a single operational route based on supply amounts of hydrogen available from a plurality of hydrogen stations respectively, from among a plurality of candidates of an operational route of each of the fuel cell electric vehicles, and a scheduling step of scheduling the filling of each of the fuel cell electric vehicles with hydrogen at the hydrogen station or hydrogen stations included on the decided operational route. In the decision step, the new operational route based on post-change available supply amounts of hydrogen is decided in the case where the supply amounts of hydrogen available from the respective hydrogen stations change when each of the fuel cell electric vehicles runs on the decided operational route.

The present disclosure makes it possible to provide an operational system, an operational method, and a storage medium that can reduce the time for filling each of fuel cell electric vehicles with hydrogen, in consideration of the status of utilization of each of a plurality of hydrogen stations.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration view showing the configuration of an operational system according to the first embodiment;

FIG. 2 is a schematic view showing the outline of a basic operational route of each of fuel cell electric vehicles in the first embodiment;

FIG. 3 is a block diagram showing the configuration of each of the fuel cell electric vehicles in the first embodiment;

FIG. 4 is a schematic configuration view showing the configuration of each of hydrogen stations in the first embodiment;

FIG. 5 is a block diagram showing the configuration of a server in the first embodiment;

FIG. 6 is a schematic view exemplifying the behavior of the server in the first embodiment; and

FIG. 7 is a flowchart showing the behavior of the operational system in the first embodiment.

### DETAILED DESCRIPTION OF EMBODIMENTS

### First Embodiment

Although the disclosure will be described hereinafter through one of the embodiments of the disclosure, the disclosure according to each of the claims is not limited to the following embodiment. Besides, not all the configurations described in the embodiment are indispensable as means for solving the problem.

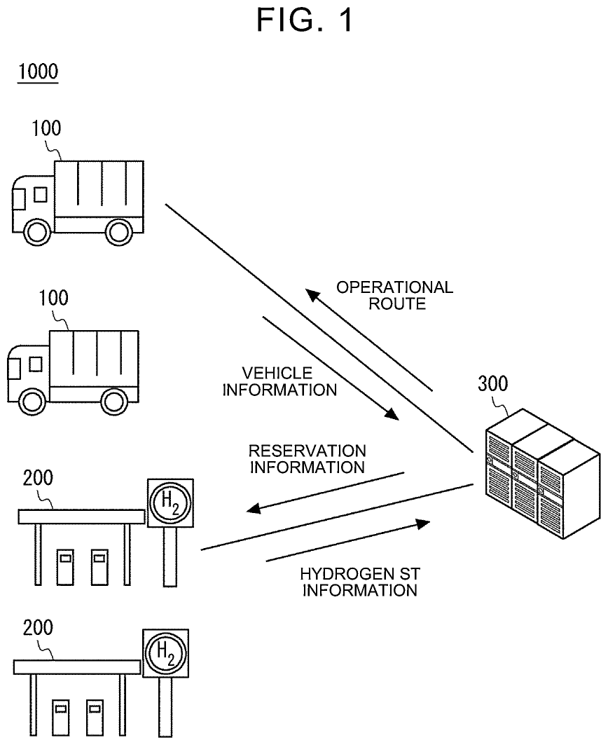

An operational system according to the first embodiment will be described hereinafter with reference to the drawings. FIG. 1 is a schematic view schematically showing the configuration of an operational system 1000 according to the first embodiment. The operational system 1000 is an operational system for a plurality of fuel cell electric vehicles. The operational system 1000 is equipped with a plurality of fuel cell electric vehicles 100, a plurality of hydrogen stations (ST's) 200, and a server 300. The server 300 is connected to the fuel cell electric vehicles 100 and the hydrogen stations 200 via a network (not shown). The network (not shown) may be a wired or wireless network.

Each of the fuel cell electric vehicles 100 is a fuel cell (FC) vehicle that is operated daily and that consumes a large amount of hydrogen per day. Each of the fuel cell electric vehicles 100 is, for example, a distribution vehicle (e.g., a truck for convenience stores), or a commercial vehicle such as a route bus. A basic operational route is set for each of the fuel cell electric vehicles 100. The basic operational route includes a plurality of via-points. In the case where each of the fuel cell electric vehicles 100 is a distribution vehicle, the basic operational route includes a plurality of distribution destinations (e.g., convenience stores). Besides, in the case where each of the fuel cell electric vehicles 100 is a route bus, the basic operational route includes a plurality of bus stops.

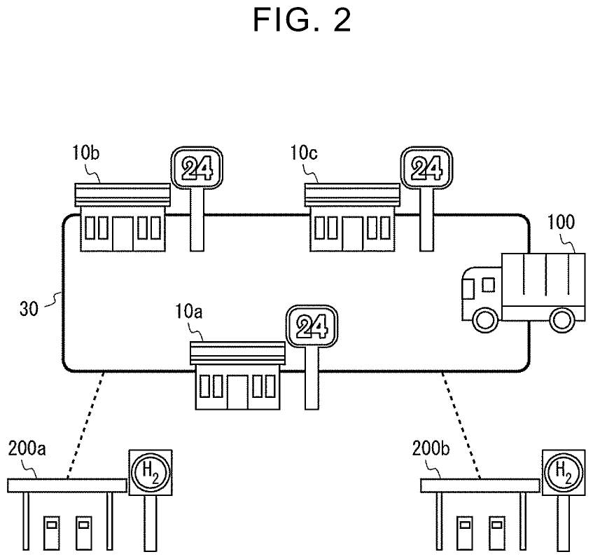

FIG. 2 is a schematic view exemplifying the basic operational route of each of the fuel cell electric vehicles 100. The fuel cell electric vehicle 100 is a distribution truck for convenience stores. A basic operational route 30 passing through convenience stores 10a, 10b, and 10c is set for the fuel cell electric vehicle 100. Hydrogen stations 200a and 200b are provided around the basic operational route 30. The hydrogen stations 200 (hereinafter referred to also as the filling ST's) where the fuel cell electric vehicle 100 is filled with hydrogen, and the like are decided by the server 300 that will be described later.

Referring again to FIG. 1, each of the fuel cell electric vehicles 100 receives the operational route from the server 300. The operational route is obtained by adding a route passing through the hydrogen stations 200 to the basic operational route. In other words, the operational route of the fuel cell electric vehicle 100 includes at least one of the hydrogen stations 200 where the fuel cell electric vehicle 100 is filled with hydrogen, and a plurality of via-points (e.g., convenience stores). Besides, the fuel cell electric vehicle 100 transmits vehicle information to the server 300. The vehicle information includes a traffic situation around the fuel cell electric vehicle 100, an average gas mileage, a remaining amount of hydrogen, and the like.

The fuel cell electric vehicle 100 runs along the operational route received from the server 300. The fuel cell electric vehicle 100 may be an automated driving vehicle, or a non-automated driving vehicle that is driven by a human being. In the case of an automated driving vehicle, the fuel cell electric vehicle 100 is equipped with a sensor (not shown), and autonomously runs along the operational route. In the case of a non-automated driving vehicle, the fuel cell electric vehicle 100 causes a display device (e.g., a monitor of a car navigation device) to display the operational route. A driver then causes the fuel cell electric vehicle 100 to run along the operational route.

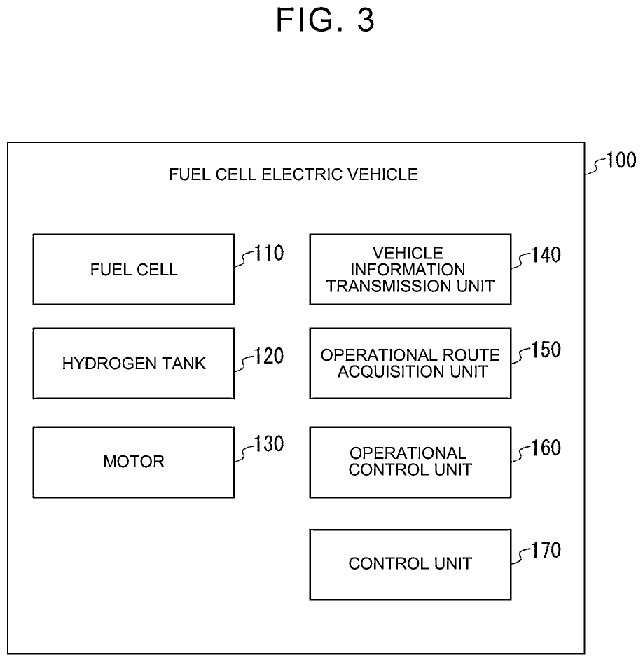

Next, the configuration of the fuel cell electric vehicle will be described with reference to FIG. 3. FIG. 3 is a block diagram showing the configuration of each of the fuel cell electric vehicles 100. The fuel cell electric vehicle 100 is equipped with a fuel cell 110, a hydrogen tank 120, a motor 130, a vehicle information transmission unit 140, an operational route acquisition unit 150, an operational control unit 160, and a control unit 170. The fuel cell 110 generates electric power through the use of the hydrogen stored in the hydrogen tank 120. The motor 130 is driven by the electric energy generated by the fuel cell 110.

The vehicle information transmission unit 140 transmits vehicle information on the fuel cell electric vehicle 100 to the server 300. The vehicle information includes a traffic situation (referred to also as an operational situation) around the fuel cell electric vehicle 100, a remaining amount of hydrogen, an average gas mileage, and the like. The traffic situation concretely represents a degree of congestion. The traffic situation may be detected via a sensor (not shown). The remaining amount of hydrogen is a remaining amount of hydrogen stored in the hydrogen tank 120. The average gas mileage represents a distance over which the fuel cell electric vehicle 100 can run with the hydrogen of unit capacity, or the like.

The operational route acquisition unit 150 acquires an operational route of the fuel cell electric vehicle 100 from the server 300. The operational control unit 160 causes a display device (not shown) to display the operational route. Alternatively, the operational control unit 160 causes the fuel cell electric vehicle 100 to autonomously run along the operational route. The control unit 170 includes a processor, a memory, and the like, and controls the above-mentioned respective control blocks.

Referring again to FIG. 1, each of the hydrogen stations 200 is located around a basic running route of each of the fuel cell electric vehicles 100. The hydrogen station 200 fills the hydrogen tank 120 of the fuel cell electric vehicle 100 with hydrogen. The hydrogen station 200 transmits hydrogen station (ST) information to the server 300. The hydrogen ST information includes information representing an available supply amount of hydrogen. Besides, the hydrogen station 200 receives reservation information from the server 300.

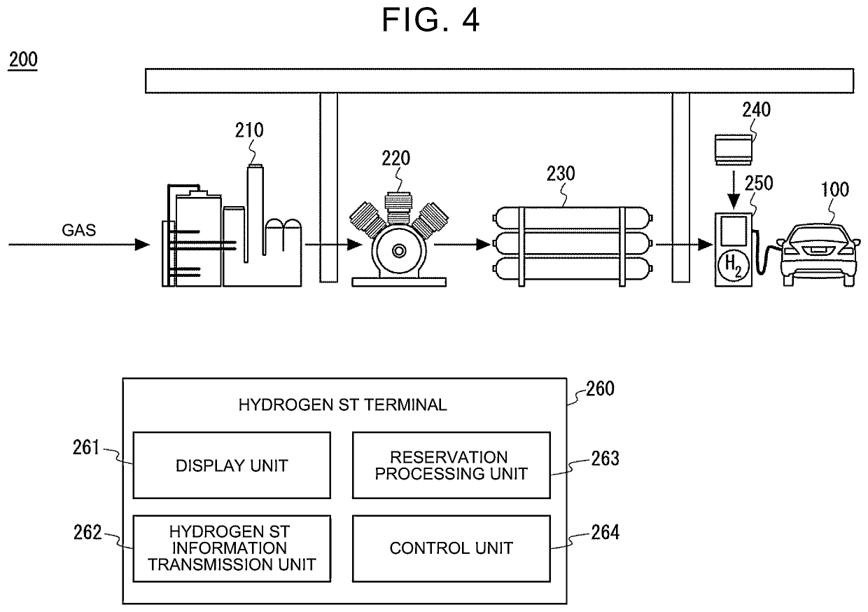

Next, the configuration of each of the hydrogen stations 200 will be described in detail with reference to FIG. 4. The hydrogen station 200 is equipped with a hydrogen manufacturing device 210, a compressor 220, an accumulator 230, a pre-cooler 240, a dispenser 250, and a hydrogen ST terminal 260.

FIG. 4 shows an on-site type hydrogen station, that is, the hydrogen station 200 in which hydrogen is manufactured. However, the hydrogen station 200 may be an off-site type hydrogen station that stores the hydrogen manufactured outside. In this case, the hydrogen station 200 may not be equipped with the hydrogen manufacturing device 210.

The hydrogen manufacturing device 210 produces hydrogen from liquefied petroleum (LP) gas, city gas, or the like. The compressor 220 compresses the manufactured hydrogen, raises the pressure of the hydrogen to a predetermined pressure, and accumulates the hydrogen in the accumulator 230 that will be described later. The compressor 220 may mechanically compress hydrogen with the aid of, for example, a cylinder and a piston.

The accumulator 230 stores the hydrogen at the raised pressure. It is known that the accumulation of hydrogen takes a long time when the amount of hydrogen in the accumulator is small. In particular, when a vehicle that is designed to be filled with a large amount of hydrogen (e.g., a truck) is filled with hydrogen, the amount of hydrogen in the accumulator becomes small. Accordingly, it takes a long time until a sufficient amount of hydrogen is accumulated, so the next vehicle has to wait to be filled with hydrogen.

The pre-cooler 240 is a device that cools hydrogen in advance such that the temperature in the hydrogen tank 120 of the fuel cell electric vehicle 100 does not rise too much. The dispenser 250 fills (supplies) the fuel cell electric vehicle 100 with the stored hydrogen. The dispenser 250 is provided with a nozzle for supplying hydrogen, and an operator control panel.

The hydrogen ST terminal 260 includes a processor, a memory, and the like. The hydrogen ST terminal 260 is equipped with a display unit 261 such as a display, a hydrogen ST information transmission unit 262, a reservation processing unit 263, and a control unit 264.

The hydrogen ST information transmission unit 262 transmits hydrogen ST information to the server 300, for example, while the fuel cell electric vehicle 100 runs. The hydrogen ST information includes a supply amount of hydrogen available from the hydrogen station 200, and business hours of the hydrogen station 200 (hereinafter referred to also as business information). In concrete terms, the available supply amount of hydrogen may be an amount of hydrogen stored in the accumulator 230. Incidentally, the hydrogen ST information may be further provided to vehicles other than the fuel cell electric vehicle 100. By confirming the provided information, the driver of the vehicle can decide at least one of the hydrogen stations 200 to be utilized, the timing for filling, and the like.

The reservation processing unit 263 reserves the filling of the fuel cell electric vehicle 100 with hydrogen, in accordance with the reservation information acquired from the server 300. The reservation information includes pieces of information such as a scheduled filling time (referred to also as a filling timing) and a filling amount of hydrogen.

The control unit 264 includes a processor, a memory, and the like. The control unit 264 controls the above-mentioned respective control blocks. Besides, the control unit 264 causes the display unit 261 to display instructions to manufacture hydrogen and instructions to accumulate hydrogen, based on reservation information. In the case where the hydrogen station 200 is an off-site type hydrogen station, the control unit 264 may cause the display unit 261 to display instructions to arrange for the provision of hydrogen instead of instructions to manufacture hydrogen. An employee of the hydrogen station 200 manufactures hydrogen or arranges for the provision of hydrogen, and accumulates hydrogen, in accordance with the displayed instructions.

Instead of causing the display unit 261 to display instructions to manufacture hydrogen and instructions to accumulate hydrogen, the control unit 264 may directly control the hydrogen manufacturing device 210 and the accumulator 230. In this case, the hydrogen station may not be equipped with the display unit 261. Besides, in the case where the hydrogen station 200 is an off-site type hydrogen station, the control unit 264 may arrange for the provision of hydrogen (order hydrogen).

Referring again to FIG. 1, the server 300 includes a processor, a memory, and the like. The server 300 is also referred to as a management system. The server 300 has an operational program for controlling the operation of each of the fuel cell electric vehicles 100 stored in the memory. The server 300 manages the operation of the fuel cell electric vehicle 100 by executing the operational program. Incidentally, the server 300 may not necessarily be a physically single device. For example, the operation of the fuel cell electric vehicle 100 may be controlled through the performance of decentralized processing by a plurality of information processing devices connected to a network.

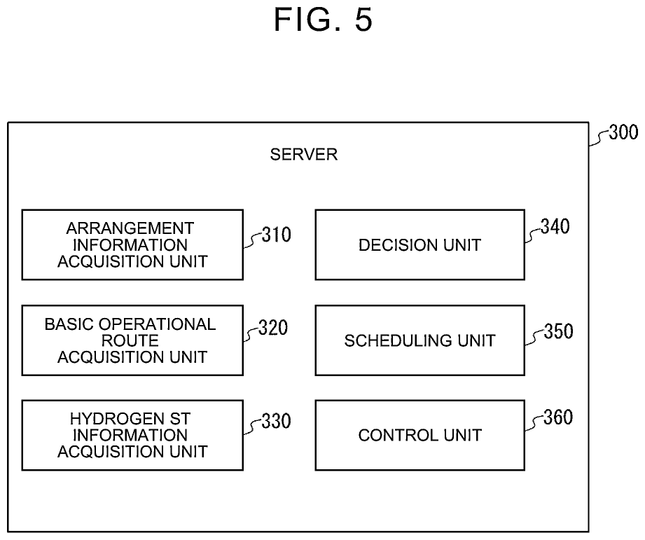

Next, the functions of the server will be described in detail with reference to FIG. 5. The server 300 is equipped with an arrangement information acquisition unit 310, a basic operational route acquisition unit 320, a hydrogen ST information acquisition unit 330, a decision unit 340, a scheduling unit 350, and a control unit 360. The arrangement information acquisition unit 310 acquires arrangement information on the hydrogen stations 200 (referred to also as an arrangement map). The arrangement information acquisition unit 310 has a memory for storing the arrangement information, or the like.

The basic operational route acquisition unit 320 acquires the basic operational route of each of the fuel cell electric vehicles 100. As described above, the basic operational route includes a plurality of via-points (e.g., distribution destinations, bus stops, and the like) through which the fuel cell electric vehicle 100 passes. The basic operational route acquisition unit 320 includes a memory for storing the basic operational route, and the like.

The hydrogen ST information acquisition unit 330 acquires hydrogen ST information. The hydrogen ST information includes a supply amount of hydrogen available from each of the hydrogen stations 200, business information on each of the hydrogen stations 200, and the like. The hydrogen ST information acquisition unit 330 has a memory for storing hydrogen ST information, and the like. The hydrogen ST information acquisition unit 330 acquires a supply amount of hydrogen available from each of the hydrogen ST's, on a real-time basis. Accordingly, the decision unit 340 that will be described later can decide the new operational route of the fuel cell electric vehicle 100 in accordance with the status of utilization of each of the hydrogen stations 200.

The decision unit 340 decides the operational route of the fuel cell electric vehicle 100 based on the arrangement information, the basic operational route, and the hydrogen ST information. The operational route includes via-points (e.g., distribution destinations and bus stops) included on the basic operational route, and the hydrogen station 200 where the fuel cell electric vehicle 100 is filled with hydrogen. Incidentally, the fuel cell electric vehicle 100 may be filled with hydrogen at two or more of the hydrogen stations 200. In this case, the decision unit 340 further decides the filling amount of hydrogen at each of the hydrogen stations 200.

As described above, the basic operational route is set for each of the fuel cell electric vehicles 100. Accordingly, the operational route of the fuel cell electric vehicle 100 can be selected from among a plurality of candidates. The candidates include, for example, routes passing through the vis-points included on the basic operational route and one of the hydrogen stations 200. Alternatively, the candidates may include, for example, routes passing through the via-points and two or more of the hydrogen stations 200. The candidates may be selected in accordance with the running time or the like.

The decision unit 340 decides a single operational route based on the supply amounts of hydrogen available from the hydrogen stations 200 respectively, from among the candidates of the operational route of the fuel cell electric vehicle 100. The decision unit 340 may decide the operational route such that the available supply amounts of hydrogen can be equalized among the hydrogen stations 200. For example, the decision unit 340 may decide the candidate in which the available supply amounts of hydrogen are equalized to the maximum extent among the hydrogen stations 200, as the operational route. It should be noted herein that the decision unit 340 may further take other elements such as the running time into account.

Furthermore, if the supply amounts of hydrogen available from the respective hydrogen stations 200 change when the fuel cell electric vehicle 100 runs on the decide operational route, the decision unit 340 decides a new operational route based on the post-change available supply amounts of hydrogen. That is, the decision unit 340 decides the running route of the fuel cell electric vehicle on a real-time basis, in accordance with the status of utilization of the hydrogen stations 200.

The decision unit 340 may decide an optimal operational route by optimizing the operational route of the fuel cell electric vehicle 100. The decision unit 340 can optimize the operational route with the aid of a known technology using an evaluation function or the like. The optimal operational route may be, for example, an operational route where the consumption amount of hydrogen is small, or an operational route where the available supply amounts of hydrogen are equalized.

The decision unit 340 outputs the decided operational route to the fuel cell electric vehicle 100. The decision unit 340 may further output information such as the filling ST's, the timing for filling, the time required for filling, and the like to the fuel cell electric vehicle 100.

The scheduling unit 350 schedules the filling of the fuel cell electric vehicle 100 with hydrogen at each of the hydrogen stations included on the decided operational route. In other words, the scheduling unit 350 reserves the filling of the fuel cell electric vehicle 100 with hydrogen at each of the hydrogen stations 200. In concrete terms, the scheduling unit 350 outputs reservation information including the scheduled arrival time (the timing for filling) of the fuel cell electric vehicle 100 and the filling amount to the hydrogen station 200.

The scheduling unit 350 may output information for instructing each of the hydrogen stations 200 to accumulate hydrogen. Thus, the operational system 1000 can not only reserve the filling of the fuel cell electric vehicle 100 with hydrogen on a real-time basis, but also accumulate hydrogen on a real-time basis.

The control unit 360 includes a processor, a memory, and the like. The control unit 360 controls the above-mentioned respective control blocks.

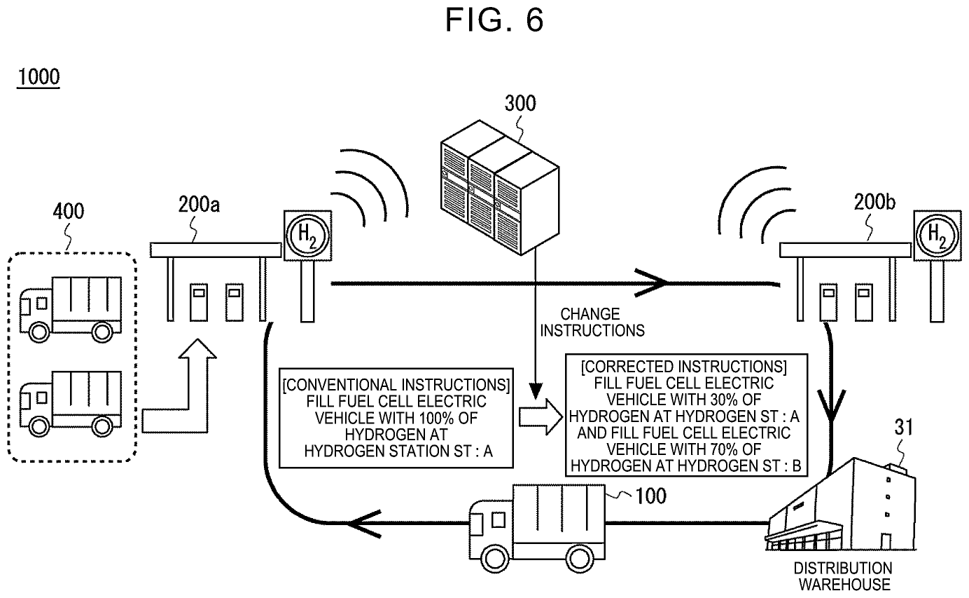

Next, the behavior of the server 300 will be concretely described with reference to FIG. 6. It is assumed that the fuel cell electric vehicle 100 is a distribution truck. A pre-change operational route includes a distribution warehouse 31 and a hydrogen station 200a (referred to also as a hydrogen ST: A). It is assumed that, according to the conventional instructions, the fuel cell electric vehicle 100 is instructed to be filled with 100% of hydrogen corresponding to the capacity of the hydrogen tank at the hydrogen station 200a. It is also assumed that a large truck 400 that consumes a large amount of hydrogen has been filled with hydrogen at the hydrogen station 200a.

After the large truck 400 is filled with hydrogen, the hydrogen station 200a transmits an available supply amount of hydrogen as hydrogen ST information. The available supply amount of hydrogen may be an amount of hydrogen stored in the accumulator 230. The decision unit 340 of the server 300 decides a new running route of the fuel cell electric vehicle 100 based on the supply amount of hydrogen available from the hydrogen station 200a, a supply amount of hydrogen available from a hydrogen station 200b (referred to also as a hydrogen ST: B), arrangement information on the hydrogen stations 200a and 200b, and via-points included on a basic distribution route (e.g., the distribution warehouse 31).

The decision unit 340 decides an operational route such that the available supply amounts of hydrogen are equalized between the hydrogen stations 200a and 200b. Since the supply amount of hydrogen available from the hydrogen station 200a has decreased, the decision unit 340 decides the operational route such that the amount of hydrogen with which the fuel cell electric vehicle 100 is filled at the hydrogen station 200b becomes large. Incidentally, the decision unit 340 may decide the operational route such that the waiting time of the fuel cell electric vehicle 100 becomes short. According to corrected instructions (referred to also as change instructions) in FIG. 6, the fuel cell electric vehicle 100 is instructed to be filled with 30% of hydrogen in the hydrogen tank 120 at the hydrogen station 200a, and to be filled with 70% of hydrogen in the hydrogen tank 120 at the hydrogen station 200b.

The operational system according to the first embodiment decides the new operational route when the supply amounts of hydrogen available from the respective hydrogen stations change while the fuel cell electric vehicle runs. Accordingly, the operational system according to the first embodiment can decide an appropriate operational route in accordance with the status of utilization of the hydrogen stations.

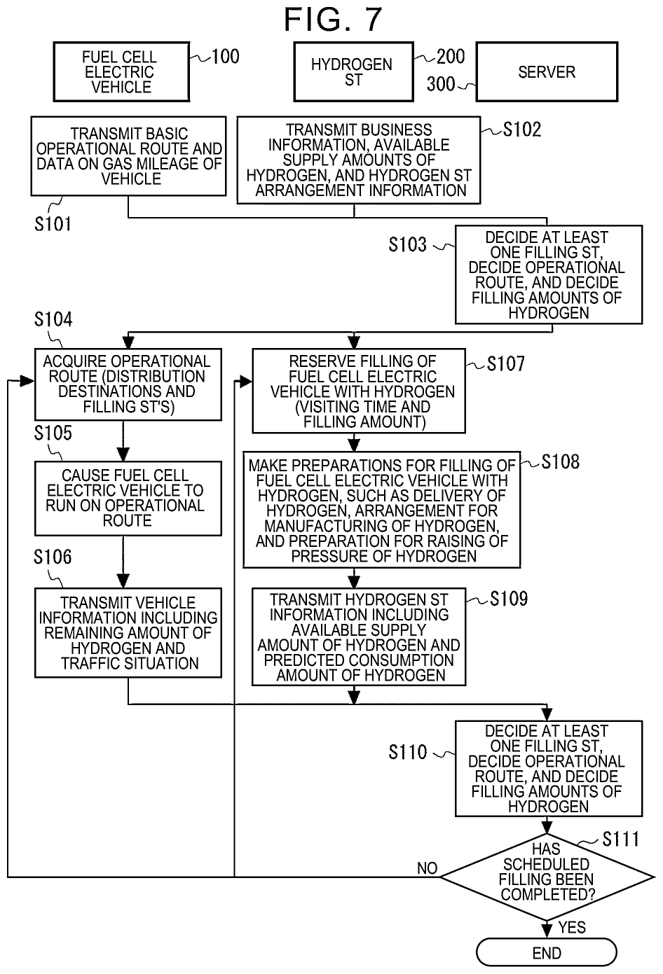

Next, an operational method according to the first embodiment will be described with reference to FIG. 7. A case where an operational route is decided in advance before the operation of each of the fuel cell electric vehicles 100 (e.g., the previous day) will be described. When the fuel cell electric vehicle 100 runs on the operational route, the server 300 decides a new operational route.

First of all, a basic operational route of the fuel cell electric vehicle 100 and data on gas mileage of the fuel cell electric vehicle 100 are transmitted to the server 300 (step S101). Then, business information on the respective hydrogen stations 200, the supply amounts of hydrogen available from the respective hydrogen stations 200, and arrangement information on the respective hydrogen stations 200 are transmitted to the server 300 (step S102). The arrangement map is also referred to as an arrangement map. Each of the available supply amounts of hydrogen can be defined as the capacity to supply hydrogen at each of the hydrogen stations.

Subsequently, the decision unit 340 of the server 300 decides at least one of the hydrogen stations 200 (the filling ST's) where the fuel cell electric vehicle 100 is to be filled with hydrogen, decides an operational route of the fuel cell electric vehicle 100, and decides a filling amount of hydrogen, based on the received information (step S103).

Subsequently, the fuel cell electric vehicle 100 acquires the operational route from the server 300 (step S104). The operational route includes via-points such as distribution destinations and the filling ST's. Subsequently, the fuel cell electric vehicle 100 runs on the acquired operational route (step S105). The fuel cell electric vehicle 100 then transmits vehicle information indicating a vehicle state of the fuel cell electric vehicle 100 to the server 300 (step S106). The vehicle information includes a remaining amount of hydrogen and a traffic situation. The traffic situation is also referred to as a road situation or an operational situation.

Each of the hydrogen stations 200 then receives reservation information on the filling of the fuel cell electric vehicle 100 with hydrogen from the scheduling unit 350 of the server 300 (step S107). The reservation information includes a visiting time (a timing for filling) of the fuel cell electric vehicle 100, and a filling amount.

Subsequently, preparations for filling the fuel cell electric vehicle 100 with hydrogen are made (step S108). The preparations for filling the fuel cell electric vehicle 100 with hydrogen include an arrangement for the manufacturing or delivery of hydrogen, and preparations for raising the pressure of hydrogen. Incidentally, the preparations for filling the fuel cell electric vehicle 100 with hydrogen may be made by a human being who has confirmed instructions (e.g., accumulation instructions) or by the hydrogen ST terminal 260.

Subsequently, each of the hydrogen stations 200 transmits hydrogen ST information (step S109). The hydrogen ST information includes a supply amount of hydrogen available from each of the hydrogen stations 200, and a predicted amount of hydrogen consumed at each of the hydrogen stations 200. The predicted consumption amount of hydrogen may be, for example, a predicted value of the amount of hydrogen consumed per unit time.

Subsequently, the decision unit 340 of the server 300 decides at least one of the filling ST's for the fuel cell electric vehicle 100, an operational route of the fuel cell electric vehicle 100, and an amount of hydrogen with which the fuel cell electric vehicle 100 is filled at each of the filling ST's, based on the information acquired in step S106 and step S109 (step S110).

Subsequently, the server 300 determines whether or not the scheduled filling of the fuel cell electric vehicle 100 with hydrogen has been completed (step S111). If the filling of the fuel cell electric vehicle 100 with hydrogen has been completed (Yes in step S111), the server 300 ends the process. On the other hand, if the filling of the fuel cell electric vehicle 100 with hydrogen has not been completed (No in step S111), the server 300 returns to the processing of step S104 and step S107.

Finally, the effects exerted by the operational system 1000 according to the first embodiment will be described. According to the conventional art, the hydrogen stations where the fuel cell electric vehicle is filled with hydrogen are decided on the previous day. It is therefore impossible to decide the optimal filling ST's and the optimal filling amounts of hydrogen in consideration of the status of the hydrogen stations around the basic operational route.

Besides, according to the conventional art, the filling of the fuel cell electric vehicle with hydrogen is reserved based on reservation information until the previous day. Accordingly, it is impossible to cope with situations where, for example, a large truck that consumes a large amount of hydrogen arrives all of a sudden, on a real-time basis. Furthermore, when one of the hydrogen stations is loaded too much, there arises a problem in that excessive capital investment is required.

Furthermore, as described above, when the amount of hydrogen accumulated at a certain one of the hydrogen stations becomes small, it takes a long time to fill the fuel cell electric vehicle with hydrogen. Moreover, when each user is allowed to decide the timing for filling the fuel cell electric vehicle with hydrogen, one or some of the hydrogen stations may be loaded too much to the extent of causing a deficiency in hydrogen. Besides, a distribution truck that operates on a tight schedule is absolutely required to be filled with hydrogen in a well-planned manner and at appropriate timings. Furthermore, when the arrival of a vehicle that consumes a large amount of hydrogen is unpredictable, there is a problem in that advance preparations are impossible to make.

In the operational system according to the first embodiment, the timings for filling and the selection of the filling ST's can be planned. Therefore, the operational route can be decided efficiently and in a well-planned manner, and the waiting time for filling the vehicle with hydrogen at each of the hydrogen stations can be reduced.

In the operational system according to the first embodiment, the volume of demand for hydrogen can be predicted. Therefore, the occurrence of a deficiency in hydrogen at each of the hydrogen stations can be prevented, and it is possible to secure hydrogen in advance for commercial vehicles that consume a large amount of hydrogen. Furthermore, with the operational system according to the first embodiment, the loads applied to the hydrogen stations can be equalized with one another, so the possibility of excessive capital investment can be reduced.

Besides, the operational system according to the first embodiment reduces the waiting time for users of general fuel cell electric vehicles, namely, non-commercial vehicles, by preventing the occurrence of a deficiency in hydrogen. Besides, the general users can easily select the timings for filling their vehicles with hydrogen and the hydrogen stations, by confirming the hydrogen ST information.

Incidentally, although the foregoing embodiment has been described as a hardware configuration, the present disclosure is not limited thereto. The present disclosure can also realize any process by causing a CPU to execute a computer program.

In the foregoing example, the program includes a group of commands (or a software code) for causing the computer to perform one or more of the functions described in the embodiment when the program is read by the computer. The program may be stored in a non-temporary computer-readable medium or a tangible storage medium. As non-restrictive examples, the computer-readable medium or the tangible storage medium includes a random-access memory (RAM), a read-only memory (ROM), a flash memory, a solid-state drive (SSD) or other memory technologies, a CD-ROM, a digital versatile disc (DVD), a Blu-ray (registered trademark) disc or other optical disc storages, a magnetic cassette, a magnetic tape, and a magnetic disc storage or other magnetic storage devices. The program may be transmitted via a temporary computer-readable medium or a communication medium. As non-restrictive examples, the temporary computer-readable medium or the communication medium includes electric, optical, acoustic or other propagated signals.

Incidentally, the disclosure is not limited to the foregoing embodiment, but can be altered as appropriate within such a range as not to depart from the gist thereof.

What is claimed is:

1. An operational system for a plurality of fuel cell electric vehicles, the operational system comprising:
a decision unit that decides a single operational route based on supply amounts of hydrogen available from a plurality of hydrogen stations respectively, from among a plurality of candidates of an operational route of each of the fuel cell electric vehicles; and
a scheduling unit that schedules filling of each of the fuel cell electric vehicles with hydrogen at the hydrogen station or hydrogen stations included on the decided operational route, wherein
the decision unit decides the new operational route based on post-change available supply amounts of hydrogen in a case where the supply amounts of hydrogen available from the respective hydrogen stations change when each of the fuel cell electric vehicles runs on the decided operational route.

2. The operational system according to claim 1, wherein the decision unit decides the operational route such that the available supply amounts of hydrogen are equalized among the hydrogen stations.

3. The operational system according to claim 1, wherein the scheduling unit further outputs information for instructing the hydrogen station where each of the fuel cell electric vehicles is scheduled to be filled with hydrogen to accumulate hydrogen.

4. The operational system according to claim 1, wherein:
a basic operational route including a plurality of via-points is set for each of the fuel cell electric vehicles; and
each of the candidates of the operational route of each of the fuel cell electric vehicles includes at least one of the hydrogen stations where each of the fuel cell electric vehicles is filled with hydrogen, and the via-points.

5. The operational system according to claim 4, wherein each of the fuel cell electric vehicles is a distribution truck or a route bus.

6. An operational method for a plurality of fuel cell electric vehicles, the operational method comprising:
a decision step of deciding a single operational route based on supply amounts of hydrogen available from a plurality of hydrogen stations respectively, from among a plurality of candidates of an operational route of each of the fuel cell electric vehicles; and
a scheduling step of scheduling filling of each of the fuel cell electric vehicles with hydrogen at the hydrogen station or hydrogen stations included on the decided operational route, wherein
the new operational route based on post-change available supply amounts of hydrogen is decided in a case where the supply amounts of hydrogen available from the respective hydrogen stations change when each of the fuel cell electric vehicles runs on the decided operational route, in the decision step.

7. A non-transitory storage medium storing an operational program that causes a computer to carry out an operational method for a plurality of fuel cell electric vehicles, wherein
the operational method includes a decision step of deciding a single operational route based on supply amounts of hydrogen available from a plurality of hydrogen stations respectively, from among a plurality of candidates of an operational route of each of the fuel cell electric vehicles, and a scheduling step of scheduling filling of each of the fuel cell electric vehicles with hydrogen at the hydrogen station or hydrogen stations included on the decided operational route, wherein
the new operational route based on post-change available supply amounts of hydrogen is decided in a case where the supply amounts of hydrogen available from the respective hydrogen stations change when each of the fuel cell electric vehicles runs on the decided operational route, in the decision step.
